(19) United States
(12) Patent Application Publication
(10) Pub. No.: US 2005/0158548 A1
(43) Pub. Date: Jul. 21, 2005

(54) Microcapsule, manufacturing method thereof and recording material

(75) Inventor: Kyoko Senga, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/030,292

(22) Filed: Jan. 7, 2005

(30) Foreign Application Priority Data
Jan. 9, 2004 (JP) 2004-004109

(51) Int. Cl. B32B 21/02

(52) U.S. Cl. 428/402.24

(57) ABSTRACT

A microcapsule prepared by a process comprising: emulsifying oil droplets comprising a core substance and a monomer having an ethylenic unsaturated double bond, in an aqueous medium; and forming microcapsule walls at an interface on oil droplets through polymerization of the monomer. A method of manufacturing a microcapsule, comprising: emulsifying oil droplets comprising a core substance and a monomer having an ethylenic unsaturated double bond, in an aqueous medium; and forming capsule walls at an interface on the oil droplets through polymerization of the monomer.

### CROSS-REFERENCE TO RELATED APPLICATION

This application claims priority under 35 USC 119 from Japanese patent Application No. 2004-4109, the disclosure of which is incorporated by reference herein.

### BACKGROUND OF THE INVENTION

1. Field of the Invention

The invention relates to a microcapsule, a manufacturing method of the microcapsule, and a recording material using the microcapsule in which various capsule properties such as humidity dependency and the like can be designed extensively.

2. Description of the Related Art

A method of forming a microcapsule is generally divided into a chemical technique, a physicochemical technique, and physical technique. Various specific methods have conventionally been proposed.

Examples of the disclosed methods include: a method utilizing coacervation of a hydrophilic wall forming material (see, for example, U.S. Pat. No. 2,800,457); an interfacial polymerization method (see, for example, U.S. Pat. No. 3,287,154, U.K. Patent No. 990443, and Japanese Patent Publication (JP-B) No. 38-19574); a method using polymer precipitation (see, for example, U.S. Pat. No. 3,418,250); a method using an isocyanate polyol wall-forming material (see, for example, U.S. Pat. No. 3,796,669); a method using an isocyanate wall-forming material (see, for example, U.S. Pat. No. 3,914,511); a method using urea-formaldehyde-based and urea-formaldehyde-resorcinol-based wall forming materials (see, for example, U.S. Pat. No. 4,001,140); a method using wall forming materials such as melamine-formaldehyde resins, hydroxypropyl cellulose or the like, (see, for example, U.S. Pat. No. 4,025,455); an in situ method utilizing monomer polymerization (see, for example, JP-B No. 36-9168); an electrolytic dispersion cooling method (see, for example, U.K. Patent No. 952807); and a spray drying method (see, for example, U.S. Pat. No. 3,111,407).

In the interfacial polymerization method, an oil phase in which a core material is dissolved or dispersed in a hydrophobic organic solvent is poured into a water-soluble polymer containing aqueous phase. This mixture was emulsified and dispersed by using a homogenizer, followed by heating. Accordingly, a polymer forming reaction occurs at an oil/water interface. Consequently, a microcapsule wall made of a polymer substance is formed, and the core material is encapsulated. This interfacial polymerization method can provide a microcapsule whose storage stability is excellent and whose particle diameter is uniform in a short period of time. Interfacial polymerization method having such advantages is extensively utilized.

In the in situ polymerization method, a capsule wall is formed by a polymerization film of a radical polymerizable monomer, and there are two cases: one case is a case where a polymer is deposited from the interior of a core material to form a capsule film; and the other case is a case where a polymer is deposited from the exterior of the core material to form a capsule film. As one of the characteristics of this method, a core material to be encapsulated is not limited to liquid, and solid or gas can be used in place of liquid.

In the field of a microcapsule used for a recording material, which is an application fields of a microcapsule, it is required to control the properties of a capsule in accordance with the target performance. Examples of the required properties of the capsule include: (1) excellent storage stability in a solution; (2) excellent long-term raw storage stability; (3) ability to suppress background fogging; (4) high transparency of material at heating; (5) stable high color development density; (6) less variation of heat sensitivity; (7) excellent lightfastness or water resistance; (8) less yellowing or blemish; and (9) heat resistance or moisture resistance.

Particularly when a heat-sensitive recording material includes a microcapsule in which a color-forming component is encapsulated, it is highly required to prevent occurrence of variation of thermal sensitivity or color development density of the heat-sensitive recording material due to a change in environmental humidity. However, a conventional capsule wall material or a conventional capsule-forming method could not satisfy such a request.

As a method of enhancing resistance of the microcapsule to water or moisture, there has been proposed a double-wall structure comprising a primary wall formed by an amino resin and a secondary wall formed by a poly-ion complex including a cationic polyamide-epihalohydrin resin and polystyrene sulfonic acid (for example, see Japanese Patent Application Laid-Open (JP-A) No. 05-007767). However, with this method, a range of choice of the desired performance is limited or production suitability is insufficient. Accordingly, a microcapsule, which can control various properties of a capsule more conveniently, is required.

Further, there has been proposed a heat-resistant microcapsule in which a wall-forming film is formed by a particular melamine resin, and a heat-resistant layer comprising heat-resistant particles and silicone oil is coated on the surface of the wall-forming film (for example, see JP-A No. 06-339624). However, such a heat-resistant microcapsule must be prepared under a special environment. For this reason, development of a microcapsule manufacturing method which can be applied to more general use is required.

As described above, there are needs for a new microcapsule forming method which is capable of further enhancing usefulness or effectiveness of a microcapsule. In this method, an extent of choice of materials for forming a capsule wall must be broadened and production suitability has to be such that the materials can be combined freely to form microcapsules.

### SUMMARY OF THE INVENTION

In view of the aforementioned problems of the prior art, the invention has been achieved.

A first aspect of the invention is to provide a microcapsule prepared by a process comprising:
emulsifying oil droplets comprising a core substance and a monomer having an ethylenic unsaturated double bond, in an aqueous medium; and
forming capsule walls at an interface on the oil droplets through polymerization of the monomer.

A second aspect of the invention is to provide a microcapsule containing a color-forming component, prepared by a process comprising:
emulsifying oil droplets comprising the color-forming component and a monomer having an ethylenic unsaturated double bond, in an aqueous medium; and
forming capsule walls at an interface on the oil droplets through polymerization of the monomer.

A third aspect of the invention is to provide a method of manufacturing a microcapsule, comprising:
emulsifying oil droplets comprising a core substance and a monomer having an ethylenic unsaturated double bond, in an aqueous medium; and
forming capsule walls at an interface on the oil droplets through polymerization of the monomer.

A fourth aspect of the invention is to provide a method of manufacturing a microcapsule containing a color-forming component, comprising:
emulsifying oil droplets comprising the color-forming component and a monomer having an ethylenic unsaturated double bond, in an aqueous medium; and
forming capsule walls at an interface on the oil droplets through polymerization of the monomer.

A fifth aspect of the invention is to provide a recording material prepared by a process comprising:
providing a coating liquid including the microcapsule of the second aspect; and
coating the coating liquid on a support to form a recording layer.

A sixth aspect of the invention is to provide a method of manufacturing a recording material comprising:
providing a coating liquid including the microcapsule of the second aspect; and
coating the coating liquid on a support to form a recording layer.

### DESCRIPTION OF THE PRESENT INVENTION

In an embodiment, a microcapsule of the invention which contains color-forming component is prepared by: dispersing oil droplets in an aqueous medium, the oil droplets containing at least a color-forming component and a monomer having an ethylenic unsaturated double bond; and forming a microcapsule wall at the interface on the oil droplets through polymerization of the monomer having an ethylenic unsaturated double bond.

In the embodiment, since the microcapsule of the invention is structured as described above, capsule properties such as thermal sensitivity, storage stability, and dependency on humidity can be controlled conveniently and extensively by an appropriate selection of a type, a composition or a polymerization method of the monomer having an ethylenic unsaturated double bond. Therefore, it is possible to provide microcapsule liquids adapted for various purposes (such as a heat-sensitive recording material or a pressure-sensitive recording material).

The use of the microcapsule of the invention is not particularly limited and the microcapsule of the invention can be conveniently used in various applications. The microcapsule of the invention can be used conveniently as a microcapsule for encapsulating color-forming components or the like, for example in a heat-sensitive recording material or a pressure-sensitive recording material.

Hereinafter, main structural requirements of the microcapsule of the invention, a manufacturing method thereof, and a heat-sensitive recording material using the microcapsule will be explained in more detail.

(Monomer Having an Ethylenic Unsaturated Double Bond)

The microcapsule wall of the invention is formed through a polymerization of a monomer having an ethylenic unsaturated double bond (hereinafter, sometimes referred to as “the monomer of the invention”). As the monomer of the invention, any monomer having at least an ethylenic unsaturated double bond can be selected and used as long as the effects of the invention can be obtained. Two or more kinds of monomers may be used in combination.

Specific examples of the monomers of the invention include: acrylic acid and salts thereof, acrylic esters, and acrylamides; methacrylic acid and salts thereof, methacrylic esters, and methacrylamides; maleic acid, maleic anhydride, maleic esters, and maleic acid amides; itaconic acid, itaconic esters, and itaconic acid amides; styrenes and substituted styrenes; vinylethers, vinylesters, and N-vinyl heterocycles; and allylethers, allylesters, and N-allyl heterocycles; isopropenylethers, isopropenylesters, and N-isopropenyl heterocycles.

Examples of the acrylic esters include: methyl acrylate; ethyl acrylate, (n- or i-)propyl acrylate, (n-, i-, sec- or t-)butyl acrylate, amyl acrylate, 2-ethylhexyl acrylate, dodecyl acrylate, chloroethyl acrylate, 2-hydroxyethyl acrylate, 2-hydroxypropyl acryalte, 5-hydroxypentyl acrylate, cyclohexyl acrylate, allyl acrylate, trimethylolpropan monoacrylate, pentaerythritol monoacrylate, glycidyl acrylate, benzyl acrylate, methoxybenzyl acrylate, chlorobenzyl acrylate, 2-(p-hydroxyphenyl)ethyl acrylate, furfuryl acrylate, tetrahydrofurfuryl acrylate, phenyl acrylate, chlorophenyl acrylate, and sulfamoylphenyl acryalte.

Examples of the methacrylic esters include: methyl methacrylate, ethyl methacrylate, (n, or i-)propyl methacrylate, (n, i-, sec- or t-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 5-hydroxypentyl methacrylate, cyclohexyl methacrylate, allyl methacrylate, trimethylolpropane monomethacrylate, pentaerythritol monomethacrylate, glycidyl methacrylate, methoxybenzyl methacrylate, chlorobenzyl methacrylate, 2-(p-hydroxyphenyl)ethyl methacrylate, furfuryl methacrylate, tetrahydrofurfuryl methacrylate, phenyl methacrylate, chlorophenyl methacrylate, and sulfamoylphenyl methacrylate.

Examples of the acrylamide include: acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide, and N-hydroxyethyl-N-methylacrylamide.

Examples of the methacryamides include: methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide, and N-hydroxyethyl-N-methylmethacrylamide.

Examples of the vinyl ethers include: methylvinyl ether, butylvinyl ether, hexylvinyl ether, methoxyethylvinyl ether, and dimethylaminoethylvinyl ether.

Examples of the vinyl esters include: vinyl acetate, vinyl butylate, and vinyl bensoate.

Examples of the styrenes include: styrene, methyl styrene, dimethyl styrene, trimethyl styrene, ethyl styrene, propyl styrene, cyclohexyl styrene, chloromethyl styrene, trifluoromethyl styrene, ethoxymethyl styrene, acethoxymethyl styrene, methoxy styrene, dimethoxy styrene, chlorostyrene, dichlorostyrene, bromostyrene, iodostyrene, fluorostyrene, and carboxystyrene.

In the invention, in order to obtain a capsule wall which gives desired color-forming characteristics, the content of the monomer having an ethylenic unsaturated double bond relative to the mass of oil drops is preferably 5 to 95%, more preferably, 10 to 90%, and particularly preferably 15 to 80%, and most preferably, 20 to 50%. If the content is 5% or lower, background fogging may occur. Meanwhile, if the content is 95% or higher, thermal sensitivity could be unsatisfactory and sufficient color optical density cannot be obtained in some cases.

Among the unsaturated monomers of the invention, from a standpoint of availability as a raw material and efficiency at capsule wall formation, acrylic acid esters having 20 or less carbon atoms, methacrylic acid esters having 20 or less carbon atoms, acrylamides having 20 or less carbon atoms, methacrylamides having 20 or less carbon atoms, vinylethers having 20 or less carbon atoms, vinylesters having 20 or less carbon atoms, and styrenes having 20 or less carbon atoms are particularly preferable.

Further, the monomers used in the invention each of which has an ethylenic unsaturated double bond preferably include a polyfunctional monomer having at least two ethylenic unsaturated double bonds since such a monomer enables efficient formation of strong capsule wall having fine mesh.

Examples of such a polyfunctional monomer include: esters of polyalcohols such as trimethylolpropane and pentaerythritol with unsaturated carboxylic acids (such as acrylic acid, methacrylic acid, itaconic acid, crotonic acid, isocrotonic acid and maleic acid); acrylic acid esters and methacrylic acid esters of polyphenols such as resorcinol, pyrogallol and phloroglucinol; acrylic acid esters and methacrylic acid esters of bisphenols; amide compounds of unsaturated carbonic acids with aliphatic polyamine compounds; and acrylate terminal epoxys, methacrylate terminal epoxys, acrylate terminal polyesters, and methacrylate terminal polyesters.

Specific examples of the polyfunctional monomers comprising esters of polyalcohols with unsaturated carboxylic acids include: ethyleneglycol diacrylate, triethyleneglycol diacrylate, 1,3-butanediol diacrylate, tetramethyleneglycol diacrylate, propyleneglycol diacrylate, neopentylglycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethyleneglycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Specific examples of the methacrylic esters include: tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Specific examples of the itaconic esters include: ethyleneglycol diitaconate, propyleneglycol diitaconate, 1,3-butanediol diitaconate, 1,4-butanediol diitaconate, tetramethyleneglycol diitaconate, pentaerythritol diitaconate, and sorbitol tetraitaconate.

Specific examples of the maleic esters include: ethylene glycol dimaleate, triethylene glycol dimaleate, pentaerythritol dimaleate, and sorbitol tetramaleate.

Specific examples of the crotonic esters include: ethylene glycol dicrotonate, tetramethylene glycol dicrotonate, pentaerythritol dicrotonate, and sorbitol tetracrotonate. Specific examples of the isocrotonic esters include: ethylene glycol diisocrotonate, pentaerythritol diisocrotonate, and sorbitol tetraisocrotonate.

Specific examples of the polyfunctional monomer comprising an amide compound of an aliphatic polyamine compound with an unsaturated carboxylic acid include: methylene bisacrylamide, methylene bismethacrylamide, 1,6-hexamethylene bisacrylamide, 1,6-hexamethylene bismethacrylamide, diethylenetriamine trisacrylamide, xylylene bisacrylamide and xylylene bismethacrylamide.

Among the polyfunctional monomers, ethyleneglycol diacrylate, ethyleneglycol dimethacrylate, trimethylolpropane triacrylate, pentaerythritol tetraacrylate, dipentaerythritol hydroxypentaacrylate, hexanediol-1,6-dimethacrylate, and diethylene glycol dimethacrylate are particularly preferable since they are easily available as raw materials and can efficiently form a capsule wall having fine mesh.

The proportion of the monomers each having two or more ethylenic unsaturated double bonds relative to the monomers each having at least one ethylenic unsaturated double bond used for the invention, is preferably 90 mol % or lower, more preferably 0.1 to 70 mol %, and particularly preferably 1.0 to 50 mol % since the strength, fineness of the mesh or forming efficiency of a capsule wall are further improved with such a proportion. If the proportion of the polyfunctional monomer exceeds 90 mol %, heat sensitivity, color optical density or the like is unsatisfactory in some cases.

A molecular weight of the monomer in the invention is not particularly limited and can be chosen in accordance with the purpose of use. However, generally, the molecular weight is preferably about 100 to 5,000, and more preferably about 300 to about 2,000, considering compatibility, stability, and production suitability.

Particularly when the microcapsule of the invention is used for a heat-sensitive recording material or a pressure-sensitive recording material, the glass transition temperature (Tg) of the polymer constituting the microcapsule wall formed through polymerization of the unsaturated double bond in the monomer of the invention is preferably 40° C. or higher, more preferably 50° C. or higher, and most preferably 60° C. or higher so as to secure raw storage stability and to suppress background fogging. If the glass transition temperature (Tg) of the polymer constituting the microcapsule wall is lower than 40° C., raw storage stability may deteriorate and background fogging may occur. The upper limit of the glass transition temperature is not particularly limited. In usual uses, a polymer with a glass transition temperature within a range of about 160 to about 180° C. shows satisfactory characteristics.

Particularly, when the microcapsule of the invention is used for a heat-sensitive recording material or a pressure-sensitive recording material, in order to weaken dependency on humidity or the like, the solubility parameter (SP value) of the polymer constituting the microcapsule wall is preferably 20 (MPa)^{1/2} or lower.

This solubility parameter (SP value) is a factor defined as a square root of cohesive energy density, and represents an intermolecular force. The SP value is one way of quantitatively expressing polarity of polymer or a low molecular compound such as solvent, and can be calculated according to an equation shown below or an actual measurment;
SP value(δ)=(ΔEv/V)^{1/2}

In the equation, ΔEv represents molar vaporization energy and V represents molar volume.

Further, as the ΔEv may be determined by summing up molar vaporation heat values (Δeᵢ) of the respective atomic groups and V may be determined by summing up molar volume values (vi) of the respective atomic groups; Δeᵢ values and vi values are described in “POLYMER ENGINEERING AND FEBRUARY (Vol. 14, No. 2, pp. 151-153, 1974) written by ROBERT F. FEDRORS.

In a conventional interface polymerization method, there has been a limit to largely change polarity of the polymer constituting a microcapsule. According to the method of the invention, by selecting an appropriate compound having an ethylenic unsaturated double bond, microcapsules constituted by polymers having various polarities ranging from high polarity to low polarity or non polarity. In other words, capsules can be freely designed so as to have a desired properties selected from a wide range. In particular, in a conventional art, it has been extremely difficult to manufacture microcapsules having low-polarity or non-polarity. However, the method of the invention made it possible to easily manufacture microcapsules constituted by various polymers each having an SP value of 20 (MPa)^{1/2} or lower. Accordingly, for example, in a heat-sensitive recording material using the microcapsule manufactured by the method of the invention, it becomes possible to freely design various properties such as heat sensitivity, dependency on humidity, and the like.

Reference of SP values of representative polymers can be made to, for example, “Plastic Kako Gijutsu Binran” (published by Nikkan Kogyo Shinbun Co., Ltd., 1969). Specific SP values of polymers that can be used in the invention are shown below. The unit of all the SP values is (MPa)^{1/2}.

| | |
|---|---|
| polytetrafluoroethylene (TEFLON (R)) | 12.7 |
| silicon (polydimethylsiloxane) | 14.9 |
| butyl rubber | 15.7 |
| polypropylene | 16.0 to 16.4 |
| polyethylene | 16.2 |
| natural rubber | 16.2 to 17.0 |
| butadiene | 18.0 |
| butadiene-styrene copolymer rubber | 17.4 to 17.8 |
| polyisobutylene | 16.4 |
| polybutylacrylate | 18.0 |
| polystyrene | 17.6 to 19.8 |
| THIOKOL | 18.4 to 19.2 |
| NEOPRENE | 18.8 |
| butadiene-acrylonitril copolymer rubber | 19.2 to 19.4 |
| polyvinyl acetate | 19.2 |
| polyethylacrylate | 19.2 |
| polymethylmethacrylate | 18.4 to 19.4 |
| polyvinyl chloride | 19.4 to 19.8 |
| urea, melamine resin | 19.6 to 20.7 |
| epoxy resin | 19.8 to 22.3 |
| polyurethane | 20.5 |
| ethyl cellulose | 21.1 |
| vinyl chloride-vinyl acetate copolymer | 21.3 |
| saturated polyester (TETRON) | 21.9 |
| cellulose acetate | 22.3 |
| cellulose nitrate | 21.7 to 23.5 |
| polyoxymethylene (DELRIN) | 22.5 |
| phenol resin | 21.5 to 23.5 |
| polyvinylidene chloride | 25.0 |
| nylon | 26.0 to 27.8 |
| polymethacrylonitril | 30.7 |
| polyacrylonitril | 31.5 |

During the formation of the microcapsule of the invention, oil droplets including at least a color-forming component and a monomer having an ethylenic unsaturated double bond, are dispersed. The oil droplets may further include various substances such as high-boiling point organic solvents as oil components, low-boiling point organic solvents as auxiliary solvents, hydrophobic polymers, plasticizers, various additives, and fillers, in accordance with purposes or requirements.

(Color-Forming Component System)

The color-forming component system used in the invention is preferably a combination of a substantially colorless color-forming component (a) and a substantially colorless color-forming component (b) that is capable of reacting with the component (a) to form color. This combination is a so-called two-component color-forming component system. Further, in order to enhance storage stability while suppressing background fogging, one of the color-forming component (a) and the color-forming component (b) is encapsulated in the microcapsule of the invention.

Examples of combinations used in such a two-component color-forming system include the following combinations (1) to (18). In the following list, the former substance represents the color-forming components (a) and the latter substance represents the color-forming components (b) which is capable of reacting with the color-forming components (a) to form color:
(1) a combination of an electron donating dye precursor and an electron accepting compound;
(2) a combination of a diazonium salt compound and a coupling component (hereinafter, occasionally referred to as a “coupler compound”);
(3) a combination of a metal salt of an organic acid such as silver behenate or silver stearate and a reducing agent such as protocatechinic acid, spiroindane or hydroquinone;
(4) a combination of an iron salt of a long-chain aliphatic acid such as ferric stearate or ferric myristate and a phenol such as tannic acid, gallic acid or ammonium salicylate;
(5) a combination of a heavy metal salt of an organic acid and a sulfide of an alkali metal or alkali earth metal, or a combination of a heavy metal salt of an organic acid and an organic chelating agent, wherein examples of the heavy metal include nickel, cobalt, lead, copper, iron, mercury, and silver, examples of the organic acid include acetic acid, stearic acid, and palmitic acid, examples of the sulfide of an alkali metal or alkali earth metal include calcium sulfide, strontium sulfide, and potassium sulfide, and examples of the organic chelating agent include s-diphenyl carbazide and diphenylcarbazone;
(6) a combination of a heavy metal salt of sulfuric acid such as a sulfate of silver, lead, mercury or sodium, and a sulfur compound such as sodium tetrathionate, sodium thiosulfate, or thiourea;
(7) a combination of a ferric salt of a fatty acid such as ferric stearate and an aromatic polyhydroxy compound such as 3,4-hydroxytetraphenylmethane;
(8) a combination of a metal salt of an organic acid such as silver oxalate or mercury oxalate and an organic polyhydroxy compound such as polyhydroxy alcohol, glycerin, or glycol;
(9) a combination of a ferric salt of a fatty acid such as ferric pelargonate or ferric laurate and thiocetylcarbamide or an isothiocetylcabamide derivative;
(10) a combination of a lead salt of an organic acid such as lead caproate, lead pelargonate or lead behenate and a thiourea derivative such as ethylene thiourea or N-dodecyl thiourea;
(11) a combination of a heavy metal salt of a higher fatty acid such as ferric stearate or copper stearate and zinc dialkyldithiocarbamate;
(12) a combination which forms an oxazine dye such as a combination of resorcin and a nitroso compound;
(13) a combination of a formazan compound and a reducing agent, a combination of a formazan compound and a metal salt, or a combination of a formazan compound, a reducing agent, and a metal salt;
(14) a combination of a protected dye (or leuco dye) precursor and a deprotecting agent;
(15) a combination of an oxydization-type coloring agent and an oxidizing agent;
(16) a combination of a phthalonitrile and a diiminoisoindoline (combination which produces phthalocyanine);
(17) a combination of an isocyanate and a diiminoisoindoline (combination which produces a coloring pigment); and
(18) a combination of a pigment precursor and an acid or a base (combination which forms a pigment).

Among the above combinations, combinations (1) and (2) are preferable, which are respectively a combination of an electron donating dye precursor and an electron accepting compound and a combination of a diazonium salt compound and a coupling component. The color-forming component (a) contained in the microcapsule is preferably the electron donating dye precursor in the combination (1) or the diazonium salt compound in the combination (2).

Hereinafter, the color-forming component system (1) and (2) is explained in more detail.

(1) Combination of an Electron Donating Dye Precursor and an Electron Accepting Compound

The electron donating dye precursor used for the invention is a substantially colorless compound which is capable of donating electrons or accepting protons from acid to form color. In a preferable embodiment, the electron donating dye precursor includes a partial structure such as lactone, lactam, sulton, spiropyran, ester or amide, and the partial structure undergoes a rapid ring-opening reaction or a rapid cleavage reaction when the electron donating dye precursor contacts an electron accepting compound.

Examples of the electron donating dye precursor include: a triphenylmethane phthalide compound, a fluoran compound, a phenothiazine compound, an indolyl phthalide compound, a leucoauramine compound, a rhodamine lactam compound, a triphenylmethane compound, a triazene compound, a spiropyran compound, a fluorene compound, a pyridine compound, and a pyrazine compound.

The phthalide compound may be, for example, a compound selected from the phthalide compounds described in U.S. Reissue Pat. No. 23,024, U.S. Pat. No. 3,491,111, U.S. Pat. No. 3,491,112, U.S. Pat. No. 3,491,116 and U.S. Pat. No. 3,509,174, the disclosures of which are incorporated by reference herein. Specific examples of the phthalide compound include: 3,3-bis(p-dimethylaminophenyl)-6-dimethylaminophthalide, 3,3-bis(p-diethylamino-o-butoxyphenyl)-4-azaphthalide, and 3-(p-diethylamino-o-butoxyphenyl)-3-(1-pentyl-2-methylindol-3-yl)-4-azaphthalide, and 3-(p-dipropylamino-o-methylphenyl)-3-(1-octyl-2-methylindol-3-yl)-5-aza (or -6-aza, or -7-aza)phthalide.

The fluorane compound may be a compound selected from the fluorane compounds described in U.S. Pat. Nos. 3,624,107, No. 3,627,787, No. 3,641,011, No. 3,462,828, No. 3,681,390, No. 3,920,510 and No. 3,959,571, the disclosures of which are incorporated by reference herein. Specific examples of the fluorane compound include 2-(dibenzylamino)fluorane, 2-anilino-3-methyl-6-diethylaminofluorane, 2-anilino-3-methyl-6-dibutylaminofluorane, 2-anilino-3-methyl-6-N-ethyl-N-isoamylaminofluorane, 2-anilino-3-methyl-6-N-methyl-N-cyclohexylaminofluorane, 2-anilino-3-chloro-6-diethylaminofluorane, 2-anilino-3-methyl-6-N-ethyl-N-isobutylaminofluorane, 2-anilino-6-dibutylaminofluorane, 2-anilino-3-methyl-6-N-ethyl-N-tetrahydrofurfurylaminofluorane, 2-anilino-3-methyl-6-piperidinoaminofluorane, 2-(o-chloroanilino)-6-diethylaminofluorane, and 2-(3,4-dichlolanilino)-6-diethylaminofluorane.

The phenothiazine compound may be, for example, benzoyl leucomethylene blue or p-nitrobenzyl leucomethylene blue. The leucoauramine compound may be, for example, 4,4′-bis-dimethylaminobenzhydrine benzyl ether, N-halophenyl-leucoauramine, or N-2,4,5-trichlorophenyl leucoauramine. The rhodamine lactam compound may be, for example, rhodamine-B-anilinolactam or rhodamine-(p-nitrino)lactam. The spiropyran compound may be a compound described in U.S. Pat. No. 3,971,808, the disclosure of which is incorporated by reference herein. Specific examples of the spiropyran compound include 3-methyl-spiro-dinaphthopyran, 3-ethyl-spiro-dinaphthopyran, 3,3′-dichloro-spiro-dinaphthopyran, 3-benzyl-spiro-dinaphthopyran, 3-methyl-naphtho-(3-methyoxy-benzo)spiropyran, and 3-propyl-spiro-dibenzopyran. The pyridine compound or the pyrazine compound may be selected from the compounds described in U.S. Pat. Nos. 3,775,424, 3,853,869 and 4,246,318, the disclosures of which are incorporated by reference herein. The fluorene compound may be selected from the compounds described in Japanese Patent Application Laid-Open (JP-A) No. 63-094878, the disclosure of which is incorporated by reference herein.

If the microcapsule is used in a color heat-sensitive recording material, at least one electron donating dye precursor which is colorless and each of which can develop cyan, magenta, or yellow is used. The precursors for cyan, magenta and yellow may be selected from the precursors disclosed in U.S. Pat. No. 4,800,149, the disclosure of which is incorporated by reference herein. The precursor for yellow may be selected also from the precursors described in U.S. Pat. No. 4,800,148 (the disclosure of which is incorporated by reference herein), and the precursor for cyan may be selected also from the precursors described in JP-A No. 63-53542, the disclosure of which is incorporated by reference herein.

The content of the electron donating dye precursor in the heat-sensitive recording layer of the invention is preferably 0.01 to 3 g/m², and more preferably 0.1 to 1 g/m². When the content of the precursor is within the range, sufficient color optical density can be obtained without degradation of coatability. When the heat-sensitive material comprise a multi-layered structure consisting of a plurality of recording layers, the multi-layered structure is preferably a lamination of a plurality of recording layers each having a content of the precursor in the above range.

Next, the electron accepting compound that causes color development through a reaction with the electron donating dye precursor is explained in more detail.

Examples of the electron accepting compound usable in the invention include: 3-halo-4-hydroxybenzoic acid described in JP-A No. 4-226455 (the disclosure of which is incorporated by reference herein), methacryloxyethyl esters and acryloxyethyl esters of benzoic acid having a hydroxyl group described in JP-A No. 63-173682 (the disclosure of which is incorporated by reference herein), esters of hydroxymethylstyrene with benzoic acid having a hydroxyl group described in JP-A Nos. 59-83693, 60-141587 and 62-99190 (the disclosures of which are incorporated by reference herein), hydroxystyrene described in European Patent No. 29323, N-vinylimidazole complexes of zinc halogenide described in JP-A Nos. 62-167077 and 62-16708 (the disclosures of which are incorporated by reference herein), and electron accepting compounds described in JP-A No.63-317558 (the disclosure of which is incorporated by reference herein). Among these, 3-halo-4-hydroxybenzoic acid is particularly preferable.

Preferable specific examples of the 3-halo-4-hydroxybenzoic acid include vinylphenethyl 3-chloro-4-hydroxybenzoate, vinylphenylpropyl 3-chloro-4-hydroxybenzoate, (2-acryloyloxyethyl) 3-chloro-4-hydroxybenzoate, (2-methacryloyloxyethyl) 3-chloro-4-hydroxybenzoate, (2-acryloyloxypropyl) 3-chloro-4-hydroxybenzoate, (2-methacryloyloxypropyl) 3-chloro-4-hydroxybenzoate, (3-acryloyloxypropyl) 3-chloro-4-hydroxybenzoate, (3-methacryloyloxypropyl) 3-chloro-4-hydroxybenzoate, (4-acryloyloxybutyl) 3-chloro-4-hydroxybenzoate, (4-methacryloyloxybutyl) 3-chloro-4-hydroxybenzoate, (5-acryloyloxypentyl) 3-chloro-4-hydroxybenzoate, (5-methacryloyloxypentyl) 3-chloro-4-hydroxybenzoate, (6-acryloyloxyhexyl) 3-chloro-4-hydroxybenzoate, (6-methacryloyloxyhexyl) 3-chloro-4-hydroxybenzoate, (8-acryloyloxyoctyl) 3-chloro-4-hydroxybenzoate, and (8-methacryloyloxyoctyl) 3-chloro-4-hydroxybenzoate.

Other examples of the electron accepting compound include: styrene sulfonylaminosalicylic acid, vinylbenzyloxyphthalic acid, zinc β-methacryloxyethoxysalicylate, zinc β-acryloxyethoxysalicylate, vinyloxyethyloxybenzoic acid, β-methacryloxyethylorsellinate, β-acryloxyethylorsellinate, β-methacryloxyethoxyphenol, β-acryloxyethoxyphenol, β-methacryloxyethyl-β-resorcinate, β-acryloxyethyl-β-resorcinate, hydroxystyrene sulfonic acid N-ethylamide, β-methacryloxypropyl-p-hydroxybenzoate, β-acryloxypropyl-p-hydroxybenzoate, methacryloxymethylphenol, acryloxymethylphenol, methacrylamide propanesulfonic acid, acrylamide propanesulfonic acid, β-methacryloxyethoxydihydroxybenzene, β-acryloxyethoxydihydroxybenzene, and γ-styrenesulfonyloxy-β-methacryloxypropanecarboxylic acid;
γ-acryloxypropyl-α-hydroxyethyloxysalicylic acid, β-hydroxyethoxyphenol, β-methacryloxyethyl-p-hydroxycinnamate, β-acryloxyethyl-p-hydroxycinnamate, 3,5-distyrenesulfonic acid amidephenol, methacryloxyethoxyphthalic acid, acryloxyethoxyphthalic acid, methacrylic acid, acrylic acid, methacryloxyethoxyhydroxynaphthoic acid, acryloxyethoxyhydroxynaphthoic acid, 3-β-hydroxyethoxyphenol, β-methacryloxyethyl-p-hydroxybenzoate, β-acryloxyethyl-p-hydroxybenzoate, β′-methacryloxyethyl-β-resorcinate, β-methacryloxyethyloxycarbonylhydroxybenzoic acid, β-acryloxyethyloxycarbonylhydroxybenzoic acid, N,N′-di-β-methacryloxyethylaminosalicylic acid, N,N′-di-β-acryloxyethylaminosalicylic acid, N,N′-di-β-methacryloxyethylaminosulfonylsalicylic acid, N,N′-di-β-acryloxyethylaminosulfonylsalicylic acid, and metal salt (such as a zinc salt) thereof.

Other than the above-listed substances, examples of the electron accepting compound further include phenol derivatives, salicylic acid derivatives, metallic salts of aromatic carboxylic acids, acid clay, bentonite, novolak resins, metal-treated novolak resins and metallic complexes. These compounds are described, for example in Japanese Patent Publication (JP-B) Nos. 40-9309 and 45-14039, JP-A Nos. 52-140483, 48-51510, 57-210886, 58-87089, 59-11286, 60-176795 and 61-95988, the disclosures of which are incorporated by reference herein. Specific examples of the compounds are listed below:

Examples of the phenol derivative include 2,2′-bis(4-hydroxyphenyl)propane, 4-t-butylphenol, 4-phenylphenol, 4-hydroxydiphenoxide, 1,1′-bis(3-chloro-4-hydroxyphenyl)cyclohexane, 1,1′-bis(4-hydroxyphenyl)cyclohexane, 1,1′-bis(3-chloro-4-hydroxyphenyl)-2-ethylbutane, 4,4′-sec-isoctylidendiphenol, 4,4′-sec-butylidendiphenol, 4-tert-octylphenol, 4-p-methylphenylphenol, 4,4′-methylcyclohexylidenphenol, 4,4′-isopentylidenphenol, and benzyl p-hydroxybenzoic acid.

Examples of the salicylic acid derivative include 4-pentadecylsalicylic acid, 3,5-di(α-methylbenzyl)salicylic acid, 3,5-di(tert-octyl) salicylic acid, 5-octadecylsalicylic acid, 5-α-(p-α-methylbenzylphenyl)ethylsalicylic acid, 3-α-methylbenzyl-5-tert-octylsalicylic acid, 5-tetradecylsalycylic acid, 4-hexyloxysalicylic acid, 4-cyclohexyloxysalicylic acid, 4-decyloxysalicylic acid, 4-dodecyloxysalicylic acid, 4-pentadecyloxysalicylic acid, 4-octadecyloxysalicylic acid, zinc salts thereof, aluminum salts thereof, calcium salts thereof, and copper salts thereof.

The content of the electron accepting compound in the heat-sensitive recording layer of the invention is preferably from 0.5 to 20 parts by mass, and more preferably from 3 to 10 parts by mass, per 1 part by mass of the electron donating dye precursor. When the content of the electron accepting compound is within the range, sufficient color optical density can be obtained without decrease in sensitivity or deterioration of coatability.

(2) Combination of a Diazonium Salt Compound and a Coupling Component

The diazonium salt compound used in the invention may be, for example, a compound represented by Ar₁—N₂⁺.X⁻ (Ar represents an aromatic ring group, and X⁻ represents an acid anion). This diazonium salt compound has such characteristics that the diazonium compound quickly undergoes a coupling reaction with the coupler compound described below to develop color when heated and that the diazonium compound is degraded by light. It is possible to control the absorption peak wavelength of the diazonium compound by selecting positions or types of substituents on Ar₁ (aromatic ring group) portion.

Ar₁ represents a substituted or non-substituted aryl group. Examples of the substituent on Ar₁ include alkyl groups, alkoxy groups, alkylthio groups, aryl groups, aryloxy groups, arylthio groups, acyl groups, alkoxycarbonyl groups, carbamoyl groups, carboamide groups, sulfonyl groups, sulfamoyl groups, sulfonamide groups, ureido groups, halogen groups, amino groups, heterocyclic groups, nitro group, and cyano group. These substituents may be further substituted.

Among the aryl groups, aryl groups each having 6 to 30 carbon atoms are preferable. Examples thereof include phenyl group, 2-methylphenyl group, 2-chlorophenyl group, 2-methoxyphenyl group, 2-butoxyphenyl group, 2-(2-ethylhexyloxy)phenyl group, 2-octyloxyphenyl group, 3-(2,4-di-t-pentylphenoxyethoxy)phenyl group, 4-chlorophenyl group, 2,5-dichlorophenyl group, 2,4,6-trimethylphenyl group, 3-chlorophenyl group, 3-methylphenyl group, 3-methoxyphenyl group, 3-butoxyphenyl group, 3-cyanophenyl group, 3-(2-ethylhexyloxy)phenyl group, 3,4-dichlorophenyl group, 3,5-dichlorophenyl group, 3,4-dimethoxyphenyl group, 3-(dibutylaminocarbonylmethoxy)phenyl group, 4-cyanophenyl group, 4-methylphenyl group, 4-methoxyphenyl group, 4-butoxyphenyl group, 4-(2-ethylhexyloxy)phenyl group, 4-benzylphenyl group, 4-aminosulfonylphenyl group, 4-N,N-dibutylaminosulfonylphenyl group, 4-ethoxycarbonylphenyl group, 4-(2-ethylhexylcarbonyl)phenyl group, 4-fluorophenyl group, 3-acetylphenyl group, 2-acetylaminophenyl group, 4-(4-chlorophenylthio)phenyl group, 4-(4-methylphenyl)thio-2,5-butoxyphenyl group, and 4-(N-benzyl-N-methylamino)-2-dodecyloxycarbonylphenyl group.

Further, these groups may be substituted by an alkyloxy group, an alkylthio group, a substituted phenyl group, a cyano group, a substituted amino group, a halogen atom, and a heterocyclic group.

The content of the diazonium salt compound in the heat-sensitive recording layer of the invention is preferably 0.01 to 3 g/m², and more preferably 0.02 to 1.0 g/m². When the content of the diazonium salt compound is within the range, sufficient color development can be realized without decrease in sensitivity or elongation of suitable fixing time.

Next, the coupler compound which is capable of reacting with the diazonium salt compound to develop color is explained in more detail.

The coupler component used for the invention is capable of causing coupling reaction with the diazonium salt compound in a basic or neutral condition to form a dye. Appropriate couplers can be used together, for example, so as to obtain a desired hue. Specific examples of the couplers include resorcin, phloroglucin, 2,3-dihydroxynaphthalene, sodium 2,3-dihydroxynaphthalene-6-sulfonate, 1-hydroxy-2-naphthoic acid morpholinopropylamide, sodium 2-hydroxy-3-naphthalene sulfonate, 2-hydroxy-3-naphthalenesulfonic acid anilide, 2-hydroxy-3-naphthalenesulfonic acid morpholinopropylamide, 2-hydroxy-3-naphthalenesulfonic acid-2-ethylhexyloxypropylamide, 2-hydroxy-3-naphthalenesulfonic acid-2-ethylhexylamide, 5-acetamide-1-naphthol, sodium 1-hydroxy-8-acetamidenaphthalene-3,6-disulfonate, 1-hydroxy-8-acetamidenaphthalene-3,6-disulfonic acid dianilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide;
5,5-dimethyl-1,3-cyclohexanedione, 1,3-cyclopentanedione, 5-(2-n-tetradecyloxyphenyl)-1,3-cyclohexanedione, 5-phenyl-4-methoxycarbonyl-1,3-cyclohexanedione, 5-(2,5-di-n-octyloxyphenyl)-1,3-cyclohexanedione, N,N′-dicyclohexylbarbituric acid, N,N′-di-n-dodecylbarbituric acid, N-n-octyl-N′-n-octadecylbarbituric acid, N-phenyl-N′-(2,5-di-n-octyloxyphenyl)barbituric acid, N,N′-bis(octadecyloxycarbonylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamide-5-pyrazolone, 6-hydroxy-4-methyl-3-cyano-1-(2-ethylhexyl)-2-pyridone, 2,4-bis-(benzoylacetamide)toluene, 1,3-bis-(pivaloylacetamidemethyl)benzene, benzoylacetonitrile, thenoylacetonitrile, acetoacetanilide, benzoylacetanilide, pivaloylacetanilide, 2-chloro-5-(N-n-butylsulfamoyl)-1-pivaloylacetamidebenzene, 1-(2-ethylhexyloxypropyl)-3-cyano-4-methyl-6-hydroxy-1,2-dihydropyridine-2-one, 1-(dodecyloxypropyl)-3-acetyl-4-methyl-6-hydroxy-1,2-dihydropyridine-2-one, and 1-(4-n-octyloxyphenyl)-3-tert-butyl-5-aminopyrazole.

Regarding further details of the coupler compounds, the disclosure of the following publications can be referenced: JP-A Nos. 4-201483, 7-223367, 7-223368, 7-323660, 5-278608, 5-297024, 6-18669, 6-18670, and 7-316280, disclosures of which are incorporated by reference herein. References can also be made to JP-A Nos. 9-216468, 9-216469, 9-203472, 9-319025, 10-035113, 10-193801, and 10-264532 (disclosures of which are incorporated by reference herein), which were submitted by the present applicants.

The content of the coupler compound in the heat-sensitive recording layer is preferably 0.5 to 20 parts by mass, and more preferably 1 to 10 parts by mass, per 1 part by mass of the diazonium salt compound. When the content of the coupler compound is within the range, color development is effectively improved without degradation of coatability.

In an embodiment, the coupler compound is used in a form of a solid dispersion prepared by mixing the coupler compound with other components and water-soluble polymers and dispersing the mixture with a sand mill or the like. In another embodiment, the coupler compound is used in a form of an emulsion prepared by emulsifying the coupler compound with an appropriate emulsification aid. The methods for the solid dispersion or emulsification are not particularly limited, and an appropriate method may be selected from conventionally known methods. Details of these methods are disclosed in JP-A Nos. 59-190886, 2-141279 and 7-17145, the disclosures of which are incorporated by reference herein.

In a preferable embodiment, organic bases such as tertiary amines, piperidines, piperazines, amidines, formamidines, pyridines, guanidines, morpholines and the like are used in order to accelerate the coupling reaction. Examples of the organic bases are described in JP-A No. 57-123,086, 60-49991, 60-94381, 9-071048, 9-077729 and 9-077737, the disclosures of which are incorporated by reference herein. The amount of organic base to be used is not particularly limited, and is preferably 1 to 30 mol per 1 mol of the diazonium salt compound.

(Microcapsule Manufacturing Method)

The microcapsule manufacturing method of the invention (hereinafter, sometimes, simply referred to as, “manufacturing method of the invention”) comprises (1) dispersing oil droplets including at least a color forming component and a monomer having an ethylenic unsaturated double bond in an aqueous medium, and (2) forming a microcapsule wall at the interface on oil droplets through polymerization of the unsaturated double bond.

The polymerization of the monomer having an ethylenic unsaturated double bond may be conducted by an appropriate polymerization method selected from known polymerization methods. The polymerization method is preferably a radical polymerization method.

The microcapsule manufactured in the invention can be used in various fields without particular restriction. In any field in which microcapsules are used, the microcapsule of the invention may be used with or without being combined with another composition. In an embodiment, the microcapsule of the invention can be conveniently used in a heat-sensitive recording material or pressure-sensitive recording material in which case, the microcapsule contains a color-forming component and the like.

Although the reaction temperature during the polymerization of the monomer having an ethylenic unsaturated double bond varies depending on a type of the monomer or the like in the invention, usually, the reaction temperature is preferably within the range of 40 to 100° C., and more preferably within the range of 50 to 80° C. Further, the duration of the polymerization reaction varies depending on a type of the monomer of the invention or the like. Generally, the reaction time is preferably within the range of about 0.5 to 10 hours, and more preferably within the range of about 1 to 5 hours. The higher the temperature at which polymerization is conducted, the shorter the time required for the polymerization. However, if the encapsulated substance or the monomer is likely to be decomposed at high temperature, it is preferable to select a polymerization initiator which can act at low temperature, and to conduct the polymerization at a comparatively low temperature.

In the manufacture of the microcapsule of the invention, in order to initiate the polymerization of the monomer having an ethylenic unsaturated double bond at comparatively low temperature and to allow the polymerization reaction to proceed efficiently to completion, an appropriate polymerization initiator or a surfactant may be preferably used.

The polymerization initiator may be a photo-polymerization initiator, a thermal polymerization initiator or a redox initiator. Specific examples thereof will be listed below.

Examples of the photo-polymerization initiator include aromatic ketones such as benzophenone, 4,4-bis(dimethylamino)benzophenone, 4-methoxy-4′-dimethylamino benzophenone, 4,4′-dimethoxybenzophenone, 4-dimethylamino benzophenone, 4-dimethylaminoacetophenone, benzyl anthraquinone, 2-tert-butylanthraquinone, 2-methylanthraquinone, xanthone, thioxanthone, 2-chlolothioxanthone, 2,4-diethylthioxanthone, fuluorenone, acridone, bisacylphosphine oxides [such as bis(2,4,6-trimethylbenzoyl)phenylphosphine oxide], acylphosphine oxides [such as 2,4,6-trimethylbenzoyl-diphenylphosphine oxide];
benzoin and benzoin ethers such as benzoin methyl ether, benzoin ethyl ether, benzoin isopropyl ether and benzoin phenyl ether; 2,4,5-triaryl imidazole dimmers such as 2-(o-chlorophenyl)-4,5-diphenyl imidazole dimer, 2-(o-chlorophenyl)-4,5-di(m-methoxyphenyl)imidazole dimer, 2-(o-fluorophenyl)-4,5-diphenyl imidazole dimer, 2-(o-methoxyphenyl)-4,5-diphenyl imidazole dimer and 2-(p-methoxyphenyl)-4,5-diphenyl imidazole dimer; poly halogen compounds such as carbon tetrabromide, phenyl tribromomethyl sulfone and phenyl trichloromethyl ketone; compounds described in JP-A No. 59-133428, JP-B Nos. 57-1819 and 57-6096 and U.S. Pat. No. 3,615,455, the disclosures of which are incorporated by reference herein;

S-triazine derivatives with a trihalogenated methyl group described in JP-A No. 58-29803 (the disclosure of which is incorporated by reference herein) such as 2,4,6-tris(trichloromethyl)-S-triazine, 2-methoxy-4,6-bis(trichloromethyl)-S-triazine, 2-amino-4,6-bis(trichloromethyl)-S-triazine, and 2-(p-methoxystyryl)-4,6-bis(trichloromethyl)-S-triazine;
organic peroxides described in JP-A No. 59-189340 (the disclosure of which is incorporated by reference herein) such as methyl ethyl ketone peroxide, cyclohexanone peroxide, 3,3,5-trimethylcyclohexanone peroxide, benzoyl peroxide, ditertially butyldiperoxy isophthalate, 2,5-dimethyl-2,5-di(benzoylperoxy)hexane, tert-butylperoxy benzoate, a,a′-bis(tert-butylperoxyisopropyl)benzene, dicumyl peroxide, and 3,3′,4,4′-tetra-(tertially butylperoxy carbonyl)benzophenone;
azinium salt compounds described in U.S. Pat. No. 4,743,530 (the disclosure of which is incorporated by reference herein); organic boron compounds described in EP No. 0223587 (the disclosure of which is incorporated by reference herein) such as tetramethyl ammonium salt of triphenyl butyl borate, tetrabutyl ammonium salt of triphenylbutyl borate, and tetramethyl ammonium salt of tri(p-methoxyphenyl)butyl borate; and other diaryliodonium salts and iron allene complexes.

Further, a method in which two or more kinds of photo-polymerization initiators are used in combination is also known, and can be used in the method of manufacturing the microcapsule of the invention.

Examples of the combination of the two or more kinds of photo-polymerization initiators include (1) a combination of 2,4,5-triarylimidazole dimer and mercapto benzoxazole or the like, (2) a combination of 4,4′-bis(dimethylamino)benzophenone and benzophenone or benzoin methyl ether described in U.S. Pat. No. 3,427,161 (the disclosure of which is incorporated by reference herein) (3) a combination of benzoyl-N-methylnaphtothiazoline and 2,4-bis(trichloromethyl)-6-(4′-methoxyphenyl)-triazole described in U.S. Pat. No. 4,239,850 (the disclosure of which is incorporated by reference herein), (4) a combination of dialkylaminobenzoate ester and dimethylthioxantone described in JP-A No. 57-23602 (the disclosure of which is incorporated by reference herein), and (5) a combination of 4,4′-bis(dimethylamino)benzophenone and benzophenone and polyhalogenated methyl compound described in JP-A No. 59-78339 (the disclosure of which is incorporated by reference herein).

Examples of other photo-polymerization initiators include organic borate compounds or spectral-sensitizing-dye-based borate compounds derived from cationic dyes described in JP-A Nos. 62-143044, 9-188685, 9-188686 and 9-188710, the disclosures of which are incorporated by reference herein.

From the viewpoint of handling property or availability, the thermal polymerization initiator is preferably an azo thermal polymerization initiator, and specific examples thereof include 2,2′-azobis-4-methoxy-2,4-dimethylvaleronitrile, 2,2′-azobis-2-amidinopropane dihydrochloride, 1,1′-azobiscyclohexane-1-carbonitrile, 2,2′-azobis-2,4-dimethylvaleronitrile and 2,2′-azobis-2-methylpropanenitrile, 2,2′-azobis(isobutylonitrile) (AIBN), 2,2′-azobis(2,4-dimethylvaleronitrile), and dimethyl 2,2′-azobis(2-methylpropionate).

During the polymerization, composition or molecular weight of terminal moiety of a copolymer can be controlled by using a known chain transfer agent such as a mercapto compound.

Examples of the redox initiator include: hydrogen peroxide-Fe²⁺ salt, persulfate-NaHSO₃, and benzoyl peroxide-dimethylaniline.

Further, compounds shown below can be listed. However, the invention is not limited to these specific examples.

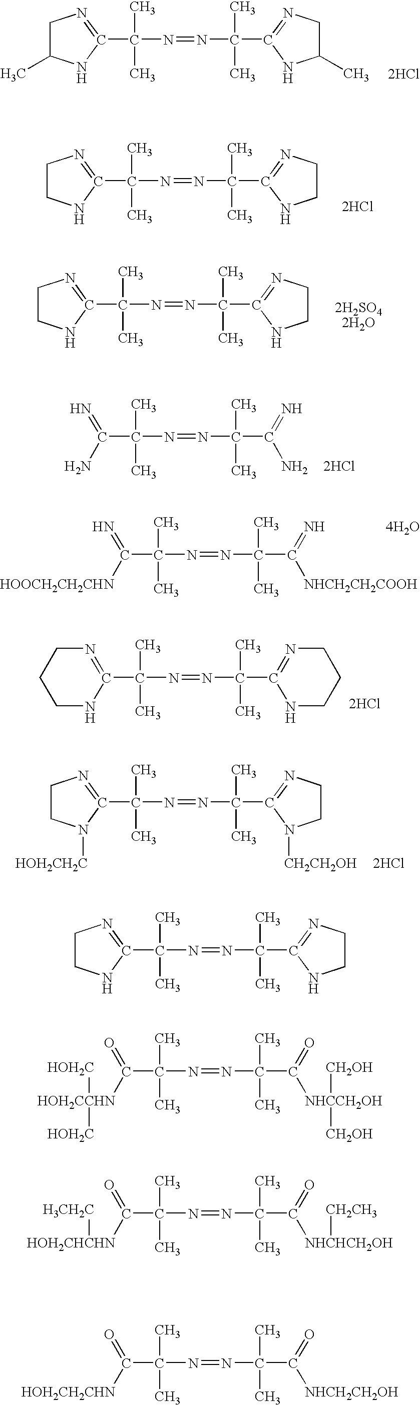

The amount of the polymerization initiator to be added is preferably 0.1 to 10 parts by mass, and more preferably 1 to 5 parts by mass, per 100 parts by mass of hydrophobic monomers.

Although the capsule wall forming method (microcapsulating method) of the invention is not limited to specific embodiments, the radical polymerization method can be preferably adopted. In the radical polymerization method, an oil phase is prepared by dissolving or dispersing a core material (the component (a) or (b), or the like) that is to become a core of the capsule in a hydrophobic organic solvent. The oil phase is poured into an aqueous phase in which a water-soluble polymer is dissolved, and emulsified by using a high speed stirring means such as a homogenizer. Thereafter, a radical polymerization reaction is initiated, ordinarily by heating, so that a microcapsule wall made of a polymer is formed at an interface on oil droplets. According to this polymerization method, a capsule having a uniform particle diameter can be formed in a short period of time. When the microcapsule of the invention is used in a heat-sensitive recording material, excellent raw storage storability can be obtained.

Hereinafter, a detailed description of the method of manufacturing the microcapsule of the invention (microcapsulating method) is given, using the aforementioned radical polymerization method as an example.

A microcapsule is preferable for use in a heat-sensitive recording materials or the like if its capsule wall prevents contact of substances outside the microcapsule with substances inside the microcapsule at ordinary temperature but allows such contact when heat and/or pressure is applied above a certain degree. Such characteristics can be freely and extensively modified by appropriately selecting the capsule wall material, capsule core substance (a substance encapsulated in a capsule), and additives.

In the invention, if a color-forming component is contained in the microcapsule, the color-forming component may be present in the state of solution or in the state of solid.

When a microcapsule is used in a heat-sensitive recording material and contains the color-forming component in the state of solution, the microcapsule can be prepared by: dissolving a color-forming component such as the electron-donating dye precursor or the diazonium salt compound in an organic solvent (and the monomer of the invention) and encapsulating the solution.

Generally, the organic solvent can be appropriately selected from high boiling point solvents and examples thereof include phosphoric esters, phthalic esters, acrylic esters, methacrylic esters, esters of other carboxylic acids, amides of fatty acids, alkylated biphenyls, alkylated terphenyls, chlorinated paraffins, alkylated naphthalenes, diallyl ethane, compounds which are solid at normal temperatures, oligomer oils and polymer oils.

Specific examples of the organic solvents include the organic solvents described in JP-A Nos. 59-178451, 59-178452, 59-178453, 59-178454, 59-178455, 59-178457, 60-242094 63-85633, 6-194825, 7-13310 and 7-13311, 9-106039 and 63-45084, the disclosures of which are incorporated by reference herein.

Further, microcapsules may be prepared without using organic solvents. In that case, so-called oil-less capsules can be obtained.

The amount of the organic solvent is preferably within the range of 1 to 500 parts by mass, and more preferably within the range of 3 to 300 parts by mass, per 100 parts by mass of the color-forming component.

If solubility of the color-forming component to be encapsulated in the organic solvent (and the monomer of the invention) is low, a low boiling point solvent which can dissolve the color-forming component efficiently can be used additionally as an auxiliary solvent. In an embodiment, only the low-boiling point solvent is used without using the high boiling point organic solvent.

Examples of the low boiling point solvent include ethyl acetate, propyl acetate, isopropyl acetate, butyl acetate and methylene chloride.

The oil phase is poured in the aqueous phase. Then, the mixture is emulsified by using a high speed stirring means such as a homogenizer. A water-soluble polymer added to the aqueous phase acts as a protective colloid which enables uniform and easy emulsification. The water-soluble polymer also acts as a dispersion medium which stabilizes the emulsion. The water-soluble polymer may be appropriately selected from known anionic polymers, nonionic polymers and amphoteric polymers.

The anionic polymers may be natural polymers or synthesized polymers, and examples thereof include polymers having a linkage group such as —COO— or —SO₂—.

Specific examples of the anionic polymers include natural products such as gum Arabic, alginic acid and pectin; semi-synthetic products such as carboxylmethyl celluloses, gelatin derivatives (such as phthalated gelatins), sulfated starch, sulfated cellulose and lignin sulfonic acid; and synthetic products such as maleic-anhydride-based copolymers (including hydrolysis products), acrylic-acid-based (methacrylic-acid-based) polymers and copolymers, vinylbenzenesulfonic-acid-based polymers and copolymers, and carboxy-modified polyvinyl alcohols.

Examples of the nonionic polymers include polyvinyl alcohols, hydroxyethyl celluloses and methyl celluloses.

Examples of the amphoteric polymers include gelatins and gelatin derivatives. Particularly, gelatins, gelatin derivatives and polyvinyl alcohols are preferable.

The water-soluble polymer may be used in a form of a 0.01 to 10% by mass aqueous solution.

Further, in an embodiment, a surfactant may be added to at least one of the oil phase and aqueous phase in order to conduct more homogeneous emulsification and to make a more stable emulsion.

The surfactant may be appropriately selected from known surfactants for emulsification. For example, such a surfactant may be selected from anionic or nonionic surfactants that the surfactant acts as the protective colloid and that the surfactant does not cause precipitation or aggregation.

Specific examples of the surfactant include sodium alkylbenzene sulfonate, sodium alkyl sulfate, sodium salt of dioctyl sulfosuccinate, and polyalkylene glycols (for instance, polyoxyethylene nonylphenyl ether).

The amount of the surfactant to be added is preferably within the range of 0.1 to 5%, and more preferably within the range of 0.5 to 2%, based on the mass of the oil phase.

After the emulsification, the capsule-wall formation reaction is initiated or accelerated. For example, when a thermal polymerization initiator is used, an emulsion is heated to a temperature of 40 to 100° C. The heat allows the monomer having an unsaturated double bond in the liquid composition to polymerize so that a capsule wall comprising a polymer component is formed at an interface on the oil droplets. During the polymerization reaction, aggregation of the capsules should be prevented. The aggregation can be prevented by adding water so as to decrease the collision probability of capsules or by stirring the emulsion sufficiently. Moreover, a dispersant can be added during the reaction in order to prevent aggregation.

Usually, the reaction is conducted for 0.5 hour to over 10 hours so that a microcapsule can be obtained which contains a color-forming component.

When the microcapsule of the invention is applied to a heat-sensitive recording material or the like, the average particle diameter of the microcapsule is preferably 20 μm or less, and from a viewpoint of obtaining an image with high resolution, more preferably 5 μm or less. Further, when the particle diameter of the formed microcapsule is too small, a surface area per weight becomes larger, whereby a lot of wall-forming materials is required. Accordingly, the average particle diameter of the microcapsule is preferably 0.001 μm or more, more preferably 0.01 μm or more, and particularly preferably 0.1 μm or more.

(Heat-Sensitive Recording Material)

It is possible to manufacture the heat-sensitive recording material of the invention by: coating a support with a coating liquid (G) and drying the coating liquid (G) so as to form a heat-sensitive recording layer, wherein the coating liquid (G) includes the microcapsule which contains the color-forming component. In this heat-sensitive recording material, the constitution of the heat-sensitive recording layer is not particularly limited. In an embodiment, the color-forming component (a), the color forming component (b), the oil component, the organic solvent and other additives are contained in the same heat-sensitive recording layer. In another embodiment, such components are contained in the same layer and there is a lamination of layers each including some of the above components.

A coating method for the coating liquids described above can be appropriately selected from known coating methods, and examples thereof include bar coating, blade coating, air knife coating, gravure coating, roll coating, spray coating, dip coating, and curtain coating. The amount of the coating liquid to be coated is preferably such an amount that the resultant recording layer has a dry film weight of 2 to 30 g/m².

A support used for the heat-sensitive recording material of the invention can be appropriately selected from known supports, and examples thereof include neutral paper, acid paper, recycle paper, polyolefine resin laminate paper, synthetic paper, polyester film, cellulose derivative film such as cellulose triacetate film, polystyrene film, and polyolefin film such as polypropyrene film and polyethylene film. These supports each may be used singly or a lamination of some supports selected from the above supports may be used.

The thickness of the support is preferably within the range of 20 to 200 μm. Further, an undercoat layer or a back layer can be provided on the support. Moreover, an intermediate layer can be provided between the support and the recording layer. These layer constitutions are disclosed in JP-A No. 61-54980 (the disclosure of which is incorporated by reference herein)or the like.

In the heat-sensitive recording material of the present invention, besides the heat-sensitive layer, other layer can be provided on the support in accordance with the necessary. In an embodiment, a protective layer is provided. In the embodiment, the protective layer comprises polyvinyl alcohol or the like as a main component and further comprises various pigments or releasing agents. In the embodiment, the purpose of providing the protective layer is, for example, to prevent sticking or head staining at thermal printing with a thermal head or to impart water-resistance to the recording material.

Further, a compound having an ultraviolet transmittance adjusting function can be contained in the protective layer so as to provide both light fastness and thermo-autochrome property. For further details of the heat-sensitive recording material comprising the compound having the ultraviolet transmittance adjusting function, reference can be made to JP-A No. 7-276808, the disclosure of which is incorporated by reference herein.

The heat-sensitive recording material of the invention can be structured as a multi-color heat-sensitive recording material by laminating, on the support, a plurality of single-color recording layers each of which can develop a color of respectively different hues.

In an embodiment, the multicolor recording material comprises a lamination of heat-sensitive recording layers (A), (B), and (C). The layer (A) comprise a combination of an electron donating dye precursor and an electron accepting compound. The layers (B) and (C) each comprise a component (a) and a component (b). The component (a) is a diazonium salt compound. The component (a) in the layer (B) has a photosensitive wavelength which is different from that of the component (a) in the layer (C). The component (b) is a coupler compound. The component (b) in each layer reacts with the component (a) in the layer to develop a color when heated. The color developed in the layer (B) has different hue from that in the layer (C). In this case, if hues developed in the layers correspond to yellow, magenta, and cyan, which are subtractive primary colors, a full-color image recording is possible.

### EXAMPLES

The invention will be further described in more detail with reference to the following examples, but the invention should not be construed as being limited thereto. In the examples, the word “part(s)” and the symbol “%” in the examples represent “part(s) by mass” and “% by mass”, unless indicated otherwise.

### Example 1

(Preparation of a Microcapsule Liquid (S))

5.3 parts of an electron donating dye precursor represented by the following formula (1), 4.1 parts of an oil component represented by the following formula (2), 83.3 parts of methyl methacrylate, 0.53 part of ethylene glycol dimethacrylate, and 0.9 part of 2,2′-azobis(2,4-dimethylvaleronitrile were dissolved in 23.3 parts of methylene chloride. The electron donating dye precursor represented by the formula (1) functions as the component (a). Methyl methacrylate and ethylene glycol dimethacrylate are monomers each having an ethylenic unsaturated double bond. 2,2′-azobis(2,4-dimethylvaleronitrile is a polymerization initiator. This solution was poured into 584.5 parts of 1.5% aqueous solution of polyvinyl alcohol (PVA217C manufactured by Kuraray Co., Ltd.), and emulsified at 5000 rpm, by using ACE homogenizer (manufactured by Nihon Seiki Co., Ltd.) for 5 minutes. The obtained emulsion was subjected to nitrogen gas substitution and allowed to react at 60° C. for 5 hours. In this way, a microcapsule liquid (S) was obtained wherein the microcapsules contain an electron donating dye and have an average particle diameter of about 0.2 μm.

The SP value (calculated by Okitsu method when the monomer was fully polymerized; other SP values in the examples and comparative examples were calculated in the same way) of the polymer constituting the walls of the microcapsules was 19.5 (MPa)^{1/2}. 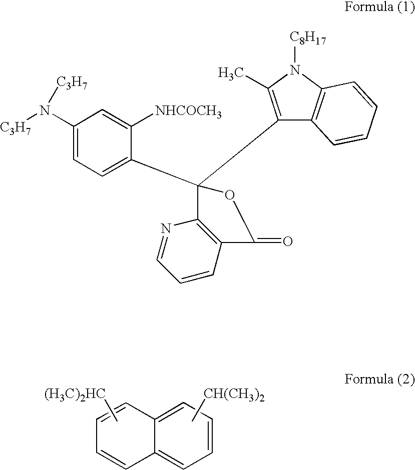
(Preparation of the Emulsion of the Electron Accepting Compound)

22.0 parts of a compound represented by the following formula (3) as the component (b), 8.0 parts of a compound represented by the following formula (4), 2.6 parts of a compound represented by the following formula (5), 2.6 parts of a compound represented by the following formula (6), 0.5 part of a compound represented by the following formula (7), and 4.0 parts of a UV absorber represented by the following formula (8), 1.0 parts of tricresylphosphate, and 0.5 part of maleic acid diethyl were added to 16.5 parts of ethyl acetate, and heated to 70° C., and dissolved. The resultant solution was poured into an aqueous phase, which was a mixture of 67 parts of water, 55 parts of 8% aqueous solution of polyvinyl alcohol (PVA 217C manufactured by Kuraray Co., Ltd.), 19.5 parts of 15% aqueous solution of polyvinyl alcohol (PVA 205C manufactured by Kuraray Co., Ltd.), 11 parts of 2% aqueous solution of a compound represented by the following formula (9), and 11 parts of 2% aqueous solution of a compound represented by the following formula (10). The mixture was emulsified by using “ACE homogenizer” (manufactured by Nihon Seiki Co., Ltd.) at 10,000 rpm so as to obtain an emulsion with an average particle diameter of 0.7 μm. Thereafter, the emulsion was stirred at 300 rpm while being maintained at 50° C., so as to vaporize ethyl acetate. Then, water was added in such an amount as to reduce the concentration of the electron accepting compound emulsion to 22%. In this way, the emulsion of the electron accepting compound was obtained. 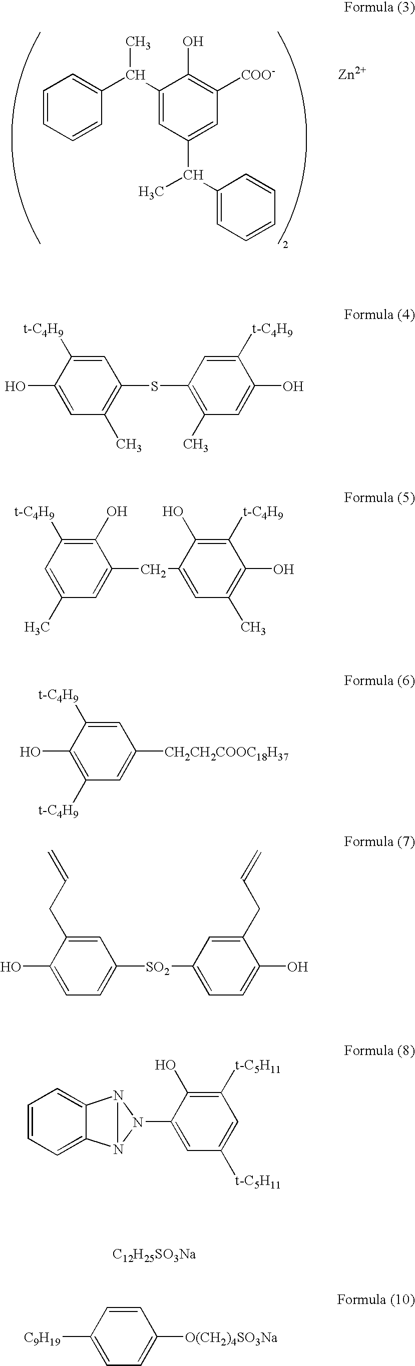
(Preparation of a Protective Layer Coating Solution)
(1) Preparation of Polyvinyl Alcohol Solution for a Protective Layer

160 parts of vinyl alcohol-alkylvinylether copolymer (EP-130 manufactured by DENKI KAGAKU KOGYO KABUSHIKI KAISHA), 8.74 parts of a mixture of sodium alkylsulfonate and polyoxylenealkylether phosphate (NEOSCORE CM-57 manufactured by Toho Chemical Industry Co., Ltd., 54% aqueous solution) and 3832 parts of water were mixed. The solutes were dissolved at 90° C. for one hour so that a uniform solution was obtained. In this way, a polyvinyl alcohol solution for a protective layer was obtained.

(2) Preparation of a Pigment Liquid Dispersion for Protective Layer

8 parts of barium sulfate (BF-21F manufactured by SAKAI CHEMICAL INDUSTRY CO., LTD., with a content of barium sulfate of at least 93%), 0.2 part of an anionic polymer activator of special polycarboxylic acid type (POIS 532A manufactured by Kao Corporation, 40% aqueous solution), and 11.8 parts of ion-exchange water were mixed, followed by dispersion with a DYNOMIL, so that a dispersion was prepared. 8.1 parts of colloidal silica (SNOWTEX O manufactured by NISSAN CHEMICAL INDUSTRIES, LTD., 20% aqueous liquid dispersion) was added to 45.6 parts of barium sulfate liquid dispersion, so that a pigment liquid dispersion for protective layer was obtained.

(3) Preparation of a Mat Agent Liquid Dispersion for Protective Layer

3.81 parts of water dispersant of 1,2-benzisothiazoline-3(2H)-on (PROXEL B. D, manufactured by I.C.I Co., Ltd.), and 1976.19 parts of water were mixed with 220 parts of wheat starch (“Wheat starch S” manufactured by Shinshin Food Co., Ltd.) followed by homogeneous dispersion, so that a mat agent liquid dispersion was obtained.

(4) Preparation of a Coating Blend Liquid for a Protective Layer

40 parts of fluorosurfactant (MEGAFAC F-120 manufactured by Dainihon Ink Chemical Industry Co., Ltd., 5% aquesous solution), 50 parts of (4-nonylphenoxytrioxyethylene) sodium butylsulfonate (manufactyured by Sankio Chemical Co., Ltd., 2.0% aqueous solution), 49.87 parts of the pigment liquid dispersion for protective layer, 16.65 parts of the mat agent liquid dispersion for protective layer, and 48.7 parts of a liquid dispersion of zinc stearate (HYDRIN F 115 manufactured by CHUKYO YUSHI CO., LTD., 20.5% aqueous solution) were homogeneously mixed with 1,000 parts of the polyvinyl alcohol solution for protective layer. In this way, the coating blend liquid for protective layer was prepared.

(Preparation of a Heat-Sensitive Recording Material)

8.4 parts of the microcapsule liquid (S) with a concentration of 28%, 7.3 parts of the electron accepting compound emulsion, 6.1 parts of the aqueous solution of the polyvinyl alcohol with a concentration of 15% (PVA217C manufactured by Kuraray Co., Ltd.), and 2.6 parts of water were mixed, so that a heat-sensitive recording layer coating liquid was obtained. This coating liquid was coated on a support which was a piece of WP paper having a thickness of 198 μm by using a coating bar and dried such that a total coating amount of the solid matter of the electron donating dye was 0.25 g/m². The coating blend liquid for protective layer was coated thereon and dried such that a total coating amount of solid matter was 1.4 g/m², whereby a heat-sensitive recording material of the invention was obtained.

### Comparative Example 1

(Preparation of a Microcapsule Liquid (T))

6.8 parts of an electron donating dye precursor represented by the formula (1) as the component (a), 5.4 parts of oil component represented by the formula (2), 14.3 parts of adductive of xylenediisocianate/trimethylol propane as a capsule wall material (TAKENATE D110N manufactured by Mitsui-Takeda Chemical Co., Ltd., 75% ethyl acetate solution) were dissolved in 16.2 parts of ethyl acetate. This solution was poured into a mixed solution of 8.5 parts of water, 51.5 parts of 8% aqueous solution of polyvinyl alcohol (PVA217C manufactured by Kuraray Co., Ltd.), and 0.4 part of 10% aqueous solution of a surfactant represented by the following formula (22), followed by emulsification at 42° C. by using ACE homogenizer (manufactured by Nihon Seiki Co., Ltd.) at 7000 rpm for 10 minutes. To this emulsion was added 61.1 parts of 0.2% aqueous solution of diethylenetriamine. The mixture was maintained at 42° C. for 30 minutes while stirred, and heated to 65° C. and allowed to react for three hours. Then, water was added in such an amount as to reduce the solid concentration to 30%. As a result, a microcapsule liquid (T) having an average particle diameter of about 0.5 μm was obtained.

The SP value (by Okitsu method) of the polymer constituting the walls of the microcapsules was 24.9 (MPa)^{1/2}.

The heat-sensitive recording material of Comparative Example 1 was prepared in the same manner as in Example 1 except that the microcapsule liquid (T) was used in place of the microcapsule liquid (T).

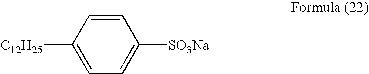

### Example 2

The heat-sensitive recording material was obtained in the same manner as in Example 1 except that 85.5 parts of styrene and 2.5 parts of divinylbenzene were used in place of 83.3 parts of methyl methacrylate and 0.53 parts of ethylene glycol methacrylate in the preparation of the microcapsule liquid.

The SP value (by Okitsu method) of the polymer which constitutes the microcapsule wall was 18.8 (MPa)^{1/2}.

(Test and Evaluation)

The heat-sensitive recording material samples were allowed to stand one night under environmental conditions of temperature: 23° C. and humidity: 50% RH. Then, the samples were heated by applying heat to the surface of the protective layer under the above temperature and humidity conditions for 10 seconds by using a static color-forming sample tester. As a result, cyan colors having color densities corresponding to respective heating temperatures were obtained. The optical density (O.D.) of the cyan color-forming portion of each sample was measured by an optical densitometer X-RITE (manufactured by X-rite Corp.). The results are shown in Table 1 below.

In another test, the heat-sensitive recording material samples were allowed to stand one night under environmental conditions of temperature: 23° C. and humidity: 20% RH. Separately, the heat-sensitive recording material samples were allowed to stand one night under environmental conditions of temperature: 23° C. and humidity and 80% RH. Each sample was heated by applying heat to the surface of the protective layer for 10 seconds using the static color-forming sample tester. As a result, a cyan color having a density corresponding to each heating temperature was obtained. The optical density (O.D.) of the cyan color-formed portion of the sample was measured by the optical densitometer X-RITE (manufactured by X-rite Corp.). In the following, a heating temperature (T₅₀) refers to a temperature at which an obtained density is 50% of the maximum optical density. The difference in the heating temperatures (T₅₀) between the two environmental humidity conditions were calculated, which was determined by an equation: T₅₀ of the sample stored at 80% RH−T₅₀ of the sample stored at 20% RH. The results of the calculation are shown in Table 2 below. A smaller difference in the heating temperature (T₅₀) refers to a smaller variation in color-forming density in different environmental humidity conditions.

TABLE 1

| | | | Comparative |
|---|---|---|---|
| | Example 1 | Example 2 | Example 1 |
| OD at 60° C. | 0.093 | 0.13 | 0.075 |
| OD at 70° C. | 0.094 | 0.13 | 0.076 |
| OD at 80° C. | 0.156 | 0.28 | 0.077 |
| OD at 90° C. | 0.336 | 0.54 | 0.084 |
| OD at 100° C. | 0.550 | 0.78 | 0.112 |
| OD at 110° C. | 0.812 | 0.987 | 0.304 |
| OD at 120° C. | 0.980 | 1.13 | 0.617 |
| OD at 130° C. | 1.16 | 1.311 | 1.00 |
| OD at 140° C. | 1.32 | 1.403 | 1.25 |
| OD at 150° C. | 1.44 | 1.56 | 1.525 |
| OD at 160° C. | 1.487 | 1.46 | 1.66 |
| OD at 170° C. | 1.50 | 1.56 | 1.635 |

TABLE 2

| | | | Comparative |
|---|---|---|---|
| | Example 1 | Example 2 | Example 1 |
| Temperature | 6.8 | 3.9 | 12.0 |
| difference (° C.) | | | |

As is apparent from Table 1 and Table 2, the heat-sensitive recording material of the invention, in which the microcapsule wall is formed through polymerization of the monomer having an ethylenic unsaturated double bond, exhibited high color-forming sensitivity even after being left to stand under high humidity, and its variation in the color optical density caused by variation in environmental humidity was suppressed to a low level. On the other hand, the heat-sensitive recording material of Comparative Example 1 formed by a conventional urethane-urea microcapsule wall showed decrease in color-forming sensitivity after being left to stand under high humidity, and its variation of the color-forming density was largely affected by the environmental humidity variation.

The present invention can provide a microcapsule, a manufacturing method thereof, and a recording material using the microcapsule in which various properties (such as raw storage stability, heat sensitivity, color optical density, background fogging, and humidity dependency) can be designed freely and extensively.

1. A microcapsule containing a color-forming component, prepared by a process comprising:
emulsifying oil droplets comprising the color-forming component and a monomer having an ethylenic unsaturated double bond, in an aqueous medium; and
forming microcapsule walls at an interface on the oil droplets through polymerization of the monomer.

2. The microcapsule according to claim 1, wherein a content of the monomer is 5 to 95% based on a mass of the oil droplets.

3. The microcapsule according to claim 1, wherein the monomer is a polyfunctional monomer having at least two ethylenic unsaturated double bonds.

4. The microcapsule according to claim 3, wherein the oil droplets further comprise another monomer having an ethylenic unsaturated double bond, and a proportion of the polyfunctional monomer is 90 mol % or less based on all monomers having an ethylenic unsaturated double bond.

5. The microcapsule according to claim 4, wherein the proportion is 0.1 to 70 mol %.

6. The microcapsule according to claim 5, wherein the proportion is 1.0 to 50 mol %.

7. The microcapsule according to claim 1, wherein a solubility parameter (SP value) of a polymer constituting the microcapsule walls is 20 (MPa)^{1/2} or lower.

8. The microcapsule according to claim 1, wherein a glass transition temperature (Tg) of the microcapsule walls is 40° C. or higher.

9. A method of manufacturing a microcapsule, comprising:
emulsifying oil droplets comprising a core substance and a monomer having an ethylenic unsaturated double bond, in an aqueous medium; and
forming microcapsule walls at an interface on the oil droplets through polymerization of the monomer.

10. The method according to claim 9, wherein the core substance is a color-forming component.

11. The method according to claim 10, wherein the monomer is a polyfunctional monomer having at least two ethylenic unsaturated double bonds.

12. The method according to claim 11, wherein the oil droplets further comprise another monomer having an ethylenic unsaturated double bond, and a proportion of the polyfunctional monomer is 90 mol % or less based on all monomers having an ethylenic unsaturated double bond.

13. A method of manufacturing a recording material comprising:
providing a coating liquid including the microcapsule of claim 1; and
coating the coating liquid on a support to form a recording layer.

14. A recording material manufactured by the method of claim 13.
